(19) United States
(12) Patent Application Publication
(10) Pub. No.: US 2016/0298955 A1
(43) Pub. Date: Oct. 13, 2016

(54) IN-SITU OPTICAL MONITORING OF FABRICATION OF INTEGRATED COMPUTATIONAL ELEMENTS

(71) Applicant: HALLIBURTON ENERGY SERVICES INC., Houston, TX (US)

(72) Inventors: David L. Perkins, The Woodlands, TX (US); Robert Paul Freese, Pittsboro, NC (US); Christopher Michael Jones, Houston, TX (US); Richard Neal Gardner, Raleigh, NC (US)

(73) Assignee: Halliburton Energy Services, Inc., Houston, TX (US)

(21) Appl. No.: 14/412,308

(22) PCT Filed: Dec. 24, 2013
(86) PCT No.: PCT/US2013/077686

§ 371 Date: Dec. 31, 2014

(51) Int. Cl. G01B 11/06; G01N 21/41

(52) U.S. Cl. CPC G01B 11/0683; G01N 21/41; E21B 49/08

(57) ABSTRACT

Techniques include receiving a design of an integrated computational element (ICE), the ICE design including specification of a substrate and a plurality of layers, their respective target thicknesses and complex refractive indices, complex refractive indices of adjacent layers being different from each other, and a notional ICE fabricated in accordance with the ICE design being related to a characteristic of a sample over an operational wavelength range; forming at least some of the layers of the ICE in accordance with the ICE design; optically monitoring, during the forming, optical properties of the formed layers using quasi-monochromatic probe-light having a probe wavelength that is outside of the operational wavelength range of the ICE; and adjusting the forming, at least in part, based on the optically monitored optical properties of the formed layers of the ICE.

### BACKGROUND

The subject matter of this disclosure is generally related to fabrication of an integrated computational element (ICE) used in optical analysis tools for analyzing a substance of interest, for example, crude petroleum, gas, water, or other wellbore fluids. For instance, the disclosed ICE fabrication uses quasi-monochromatic probe-light to in-situ optically monitor characteristics of layers of ICEs being fabricated, such that a wavelength of the quasi-monochromatic probe-light is outside of an operational wavelength range of the ICEs being fabricated.

Information about a substance can be derived through the interaction of light with that substance. The interaction changes characteristics of the light, for instance the frequency (and corresponding wavelength), intensity, polarization, and/or direction (e.g., through scattering, absorption, reflection or refraction). Chemical, thermal, physical, mechanical, optical or various other characteristics of the substance can be determined based on the changes in the characteristics of the light interacting with the substance. As such, in certain applications, one or more characteristics of crude petroleum, gas, water, or other wellbore fluids can be derived in-situ, e.g., downhole at well sites, as a result of the interaction between these substances and light.

Integrated computational elements (ICEs) enable the measurement of various chemical or physical characteristics through the use of regression techniques. An ICE selectively weights, when operated as part of optical analysis tools, light modified by a sample in at least a portion of a wavelength range such that the weightings are related to one or more characteristics of the sample. An ICE can be an optical substrate with multiple stacked dielectric layers (e.g., from about 2 to about 50 layers), each having a different complex refractive index from its adjacent layers. The specific number of layers, N, the optical properties (e.g. real and imaginary components of complex indices of refraction) of the layers, the optical properties of the substrate, and the physical thickness of each of the layers that compose the ICE are selected so that the light processed by the ICE is related to one or more characteristics of the sample. Because ICEs extract information from the light modified by a sample passively, they can be incorporated in low cost and rugged optical analysis tools. Hence, ICE-based downhole optical analysis tools can provide a relatively low cost, rugged and accurate system for monitoring quality of wellbore fluids, for instance.

Errors in fabrication of some constituent layers of an ICE design can degrade the ICE's target performance. In most cases, deviations of <0.1%, and even 0.01% or 0.0001%, from point by point design values of the optical characteristics (e.g., complex refractive indices), and/or physical characteristics (e.g., thicknesses) of the formed layers of the ICE can reduce the ICE's performance, in some cases to such an extent, that the ICE becomes operationally useless. Those familiar or currently practicing in the art will readily appreciate that the ultra-high accuracies required by ICE designs challenge the state of the art in thin film measurement techniques. For instance, complex refractive indices and thicknesses of layers of ICEs are determined during fabrication of the ICEs from results of in-situ optical monitoring. A wavelength of probe-light used for conventional in-situ optical monitoring is within an operational wavelength range of the ICEs being fabricated.

### DESCRIPTION OF DRAWINGS

FIGS. 1A-1C show multiple configurations of an example of a system for analyzing wellbore fluids that uses a well logging tool including an ICE.

FIG. 2 is a flowchart showing an example of a process for designing an ICE.

FIGS. 3A-3B show configurations of an example of a system for ICE fabrication that uses optical monitoring for which wavelength of probe-light is outside of an operational range of ICEs being fabricated.

FIGS. 3C-3G show aspects of the ICE fabrication system shown in FIG. 3A.

FIG. 4 is a flowchart showing an example of an ICE fabrication that is in-situ optically monitored such that wavelength of probe-light is outside of an operational range of fabricated ICEs.

Like reference symbols in the various drawings indicate like elements.

### DETAILED DESCRIPTION

Technologies are described for adjusting ICE fabrication in real-time or near real-time based on results of optical monitoring of characteristics of layers of ICEs being fabricated, such that a wavelength of quasi-monochromatic probe-light used for the optical monitoring is outside of an operational wavelength range of the ICEs being fabricated. The characteristics monitored in this manner can be complex refractive indices and thicknesses of the ICE layers. Note that probe-light represents any type of electromagnetic radiation having one or more probe wavelengths from an appropriate region of the electromagnetic spectrum.

The disclosed technologies can be used to perform optical monitoring that is more precise (more accurate or more repeatable) than conventional optical monitoring, which in turn leads to implementing ICE fabrication that can be more accurate or repeatable than conventional ICE fabrication. For instance, in various cases more precise results may be obtained if optical monitoring uses quasi-monochromatic probe-light with a wavelength outside the operational wavelength range in accordance with the disclosed technologies instead of a wavelength within the operational wavelength range, as used conventionally. One such case is when interaction between probe-light and materials of an ICE is weaker within an operational wavelength range of the ICE than outside of it. Another such case is when stronger and more stable light sources are available outside of an operational wavelength range of the ICE than within it. A similar such case is when more sensitive photodetectors are available outside of an operational wavelength range of the ICE than within it. Additionally, because monitoring errors are commonly directly proportional to a wavelength range of probe-light, the disclosed in-situ optical monitoring that uses probe-light wavelength shorter than a minimum wavelength of an operational wavelength range of the ICE potentially incurs smaller monitoring errors, or equivalently is potentially more accurate, than conventional optical monitoring that uses probe-light wavelength within the operational wavelength range of the ICE.

In this manner, the complex refractive indices and thicknesses of the formed layers determined from results of the disclosed in-situ optical monitoring are more accurate than if they were conventionally determined from results of conventional in-situ optical monitoring. As the determined complex refractive indices and thicknesses of the formed layers are used to adjust forming of layers of the ICE remaining to be formed, more accurate in-situ monitoring of the disclosed ICE fabrication translates into improved batch yield and yield consistency batch-to-batch relative to conventional ICE fabrication.

Prior to describing example implementations of the disclosed technologies for ICE fabrication, the following technologies are described below: in Section (1) optical analysis tools based on ICE along with examples of their use in oil/gas exploration, and in Section (2) techniques for designing an ICE.

### (1) ICE-Based Analysis of Wellbore Fluids

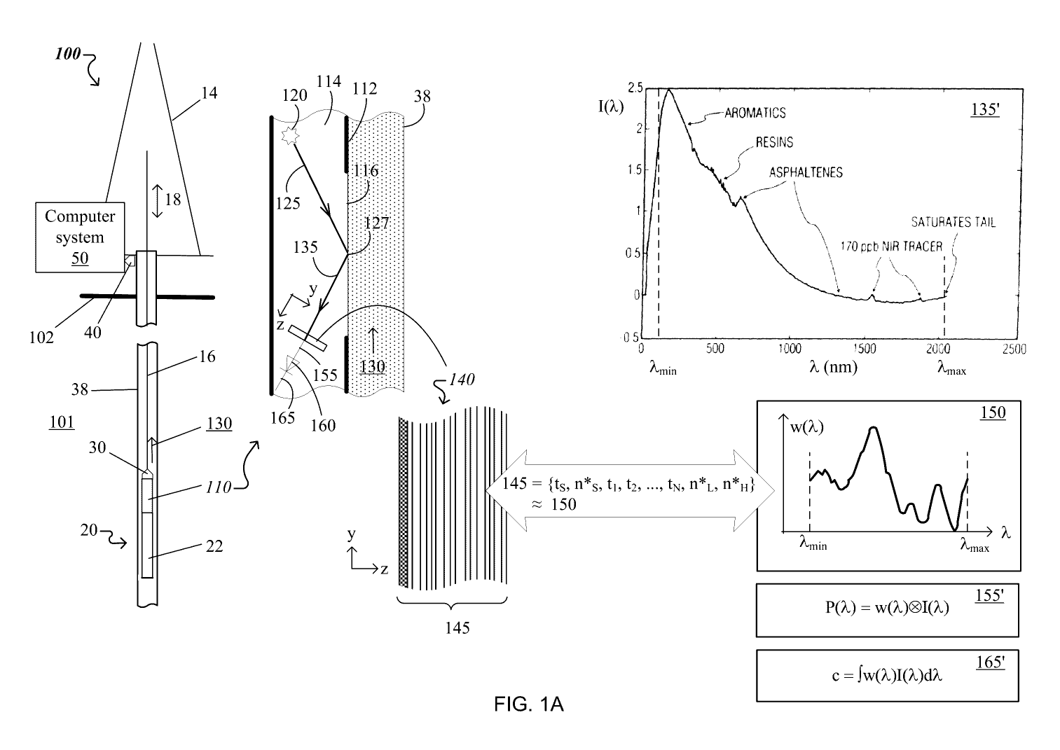

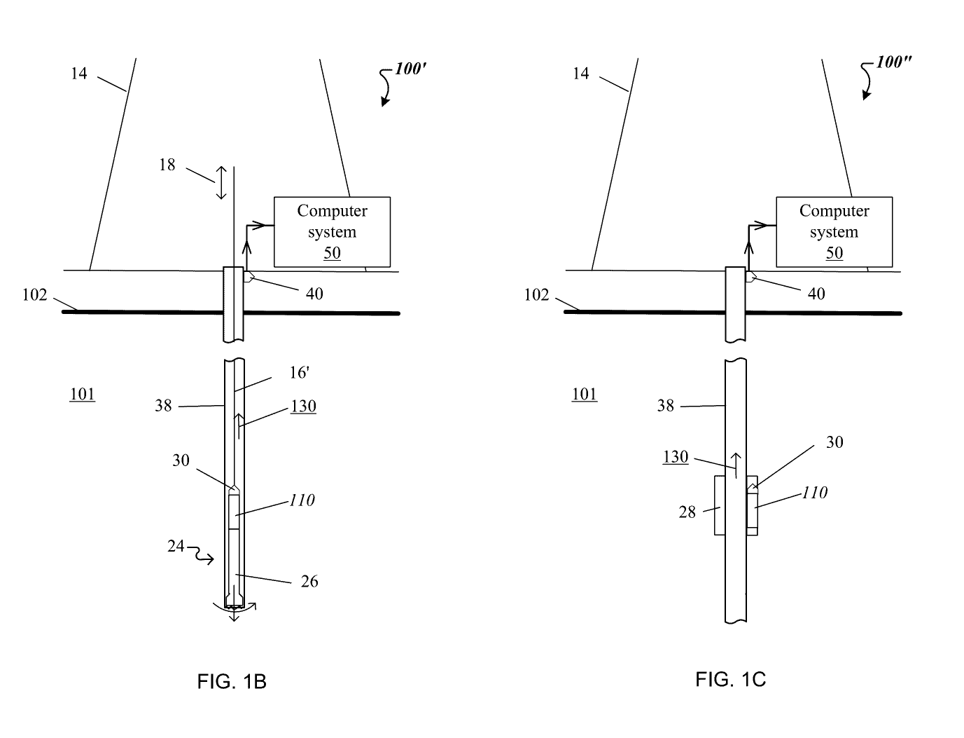

FIGS. 1A-1C show multiple configurations 100, 100′, 100″ of an example of a system for analyzing wellbore fluids 130, such that analyses are generated from measurements taken with a well logging tool 110 configured as an ICE-based optical analysis tool. The disclosed system also is referred to as a well logging system.

Each of the configurations 100, 100′, 100″ of the well logging system illustrated in FIGS. 1A-1C includes a rig 14 above the ground surface 102 and a wellbore 38 below the ground surface. The wellbore 38 extends from the ground surface into the earth 101 and generally passes through multiple geologic formations. In general, the wellbore 38 can contain wellbore fluids 130. The wellbore fluids 130 can be crude petroleum, mud, water or other substances and combinations thereof. Moreover, the wellbore fluids 130 may be at rest, or may flow toward the ground surface 102, for instance. Additionally, surface applications of the well logging tool 110 may include water monitoring and gas and crude transportation and processing.

FIG. 1A shows a configuration 100 of the well logging system which includes a tool string 20 attached to a cable 16 that can be lowered or raised in the wellbore 38 by draw works 18. The tool string 20 includes measurement and/or logging tools to generate and log information about the wellbore fluids 130 in the wellbore 38. In the configuration 100 of the well logging system, this information can be generated as a function of a distance (e.g., a depth) with respect to the ground surface 102. In the example illustrated in FIG. 1A, the tool string 20 includes the well logging tool 110, one or more additional well logging tool(s) 22, and a telemetry transmitter 30. Each of the well logging tools 110 and 22 measures one or more characteristics of the wellbore fluids 130. In some implementations, the well logging tool 110 determines values of the one or more characteristics in real time and reports those values instantaneously as they occur in the flowing stream of wellbore fluids 130, sequentially to or simultaneously with other measurement/logging tools 22 of the tool string 20.

FIG. 1B shows another configuration 100′ of the well logging system which includes a drilling tool 24 attached to a drill string 16′. The drilling tool 24 includes a drill bit 26, the ICE-based well logging tool 110 configured as a measurement while drilling (MWD) and/or logging while drilling (LWD) tool, and the telemetry transmitter 30. Drilling mud is provided through the drill string 16′ to be injected into the borehole 38 through ports of the drill bit 26. The injected drilling mud flows up the borehole 38 to be returned above the ground level 102, where the returned drilling mud can be resupplied to the drill string 16′ (not shown in FIG. 1B). In this case, the MWD/LWD-configured well logging tool 110 generates and logs information about the wellbore fluids 130 (e.g., drilling mud in this case) adjacent the working drill bit 26.

FIG. 1C shows yet another configuration 100″ of the well logging system which includes a permanent installation adjacent to the borehole 38. In some implementations, the permanent installation is a set of casing collars that reinforce the borehole 38. In this case, a casing collar 28 from among the set of casing collars supports the well logging tool 110 and the telemetry transmitter 30. In this manner, the well logging tool 110 determines and logs characteristics of the wellbore fluids 130 adjacent the underground location of the casing collar 28.

In each of the above configurations 100, 100′ and 100″ of the well logging system, the values of the one or more characteristics measured by the well logging tool 110 are provided (e.g., as a detector signal 165) to the telemetry transmitter 30. The latter communicates the measured values to a telemetry receiver 40 located above the ground surface 102. The telemetry transmitter 30 and the telemetry receiver 40 can communicate through a wired or wireless telemetry channel. In some implementations of the system configurations 100, 100′ illustrated in FIGS. 1A and 1B, e.g., in slickline or coiled tubing applications, measurement data generated by the well logging tool 110 can be written locally to memory of the well logging tool 110.

The measured values of the one or more characteristics of the wellbore fluids 130 received by the telemetry receiver 40 can be logged and analyzed by a computer system 50 associated with the rig 14. In this manner, the measurement values provided by the well logging tool 110 can be used to generate physical and chemical information about the wellbore fluids 130 in the wellbore 38.

Referring again to FIG. 1A, the well logging tool 110 includes a light source 120, an ICE 140 and an optical transducer 160. The well logging tool 110 has a frame 112 such that these components are arranged in an enclosure 114 thereof. A cross-section of the well logging tool 110 in a plane perpendicular to the page can vary, depending on the space available. For example, the well logging tool's cross-section can be circular or rectangular, for instance. The well logging tool 110 directs light to the sample 130 through an optical interface 116, e.g., a window in the frame 112. The well logging tool 110 is configured to probe the sample 130 (e.g., the wellbore fluids stationary or flowing) in the wellbore 38 through the optical interface 116 and to determine an amount (e.g., a value) of a given characteristic (also referred to as a characteristic to be measured) of the probed sample 130. The characteristic to be measured can be any one of multiple characteristics of the sample 130 including concentration of a given substance in the sample, a gas-oil-ratio (GOR), pH value, density, viscosity, etc.

The light source 120 outputs light with a source spectrum over a particular wavelength range, from a minimum wavelength λₘᵢₙ to a maximum wavelength λₘₐₓ. In some implementations, the source spectrum can have non-zero intensity over the entire or most of the wavelength range λₘₐₓ−λₘᵢₙ. In some implementations, the source spectrum extends through UV-vis (0.2-0.8 μm) and near-IR (0.8-2.5 μm) spectral ranges. Alternatively, or additionally, the source spectrum extends through near-IR and mid-IR (2.5-25 μm) spectral ranges. In some implementations, the source spectrum extends through near-IR, mid-IR and far-IR (25-100 μm) spectral ranges. In some implementations, the light source 120 is tunable and is configured in combination with time resolved signal detection and processing.

The light source 120 is arranged to direct a probe beam 125 of the source light towards the optical interface 116 where it illuminates the sample 130 at a location 127. The source light in the probe beam 125 interacts with the sample 130 and reflects off it as light modified by the sample 130. The light modified by the sample has a modified spectrum I(λ) 135′ over the particular wavelength range. In the reflective configuration of the well logging tool 110 illustrated in FIG. 1A (i.e., where the light to be analyzed reflects at the sample/window interface), the modified spectrum I(λ) 135′ is a reflection spectrum associated with the sample 130. In a transmission configuration of the well logging tool 110 (not shown in FIG. 1A), the probe beam is transmitted through the sample as modified light, such that the modified spectrum I(λ) 135′ is a transmission spectrum associated with the sample.

In general, the modified spectrum I(λ) 135′ encodes information about multiple characteristics associated with the sample 130, and more specifically the encoded information relates to current values of the multiple characteristics. In the example illustrated in FIG. 1A, the modified spectrum 135′ contains information about one or more characteristics of the wellbore fluids 130.

With continued reference to FIG. 1A, and the Cartesian coordinate system provided therein for reference, the ICE 140 is arranged to receive a beam 135 of the sample modified light, and is configured to process it and to output a beam 155 of processed light. The beam 135 of sample modified light is incident on a first surface of the ICE 140 along the z-axis, and the beam 155 of processed light is output along the z-axis after transmission through the ICE 140. Alternatively or additionally, the beam 155 (or an additional reflected beam) of processed light can be output after reflection off the first surface of the ICE 140. The ICE 140 is configured to process the sample modified light by weighting it in accordance with an optical spectrum w(λ) 150 associated with a characteristic to be measured.

The optical spectrum w(λ) 150 is determined offline by applying conventional processes to a set of calibration spectra I(λ) of the sample which correspond to respective known values of the characteristic to be measured. As illustrated by optical spectrum w(λ) 150, optical spectrums generally may include multiple local maxima (peaks) and minima (valleys) between λₘᵢₙ and λₘₐₓ. The peaks and valleys may have the same or different amplitudes. For instance, an optical spectrum w(λ) can be determined through regression analysis of N_{c} calibration spectra Iⱼ(λ) of a sample, where j=1, . . . , N_{c}, such that each of the calibration spectra IA) corresponds to an associated known value of a given characteristic for the sample. A typical number N_{c} of calibration spectra Iⱼ(Δ) used to determine the optical spectrum w(λ) 150 through such regression analysis can be N_{c}=10, 40 or 100, for instance. The regression analysis outputs, within the N_{c} calibration spectra Iⱼ(λ), a spectral pattern that is unique to the given characteristic. The spectral pattern output by the regression analysis corresponds to the optical spectrum w(λ) 150. In this manner, when a value of the given characteristic for the sample is unknown, a modified spectrum Iᵤ(λ) of the sample is acquired by interacting the probe beam 125 with the sample 130, then the modified spectrum Iᵤ(L) is weighted with the ICE 140 to determine a magnitude of the spectral pattern corresponding to the optical spectrum w(λ) 150 within the modified spectrum Iᵤ(λ). The determined magnitude is proportional to the unknown value of the given characteristic for the sample.

For example, the sample can be a mixture (e.g., the wellbore fluid 130) containing substances X, Y and Z, and the characteristic to be measured for the mixture is concentration c_{X} of substance X in the mixture. In this case, N_{c} calibration spectra IA) were acquired for N_{c} samples of the mixture having respectively known concentration values for each of the substances contained in the N_{c} samples. By applying regression analysis to the N_{c} calibration spectra Iⱼ(λ), a first spectral pattern that is unique to the concentration c_{X} of the X substance can be detected (recognized), such that the first spectral pattern corresponds to a first optical spectrum w_{cX}(λ) associated with a first ICE, for example. Similarly, second and third spectral patterns that are respectively unique to concentrations c_{Y} and c_{Z} of the Y and Z substances can also be detected, such that the second and third spectral patterns respectively correspond to second and third optical spectra w_{cY}(λ) and w_{cZ}(λ) respectively associated with second and third ICEs. In this manner, when a new sample of the mixture (e.g., the wellbore fluid 130) has an unknown concentration c_{X} of the X substance, for instance, a modified spectrum Iᵤ(λ) of the new sample can be acquired by interacting the probe beam with the mixture, then the modified spectrum Iu(λ) is weighted with the first ICE to determine a magnitude of the first spectral pattern within the modified spectrum Iᵤ(λ). The determined magnitude is proportional to the unknown value of the concentration c_{X} of the X substance for the new sample.

Referring again to FIG. 1A, the ICE 140 includes N layers of materials stacked on a substrate, such that complex refractive indices of adjacent layers are different from each other. The total number of stacked layers can be between 6 and 50, for instance. The substrate material can be BK7, diamond, Ge, ZnSe (or other transparent dielectric material), and can have a thickness in the range of 0.02-2 mm, for instance, to insure structural integrity of the ICE 140.

Throughout this specification, a complex index of refraction (or complex refractive index) n* of a material has a complex value, Re(n*)+iIm(n*). Re(n*) represents a real component of the complex index of refraction responsible for refractive properties of the material, and Im(n*) represents an imaginary component of the complex index of refraction (also known as extinction coefficient κ) responsible for absorptive properties of the material. In this specification, when it is said that a material has a high complex index of refraction n*_{H} and another material has a low complex index of refraction n*_{L}, the real component Re(n*_{H}) of the high complex index of refraction n*_{H} is larger than the real component Re(n*_{L}) of the low complex index of refraction n*_{L}, Re(n*_{H})>Re(n*_{L}). Materials of adjacent layers of the ICE are selected to have a high complex index of refraction n*_{H} (e.g., Si), and a low complex index of refraction n*_{L} (e.g., SiO₂). Here, Re(n*_{Si}) 2.4>Re(n*_{SiO2})≈1.5. For other material pairings, however, the difference between the high complex refractive index n*_{H} and low complex refractive index n*_{L} may be much smaller, e.g., Re(n*_{H})≈1.6>Re(n*_{L})≈1.5. The use of two materials for fabricating the N layers is chosen for illustrative purposes only. For example, a plurality of materials having different complex indices of refraction, respectively, can be used. Here, the materials used to construct the ICE are chosen to achieve a desired optical spectrum w(λ) 150.

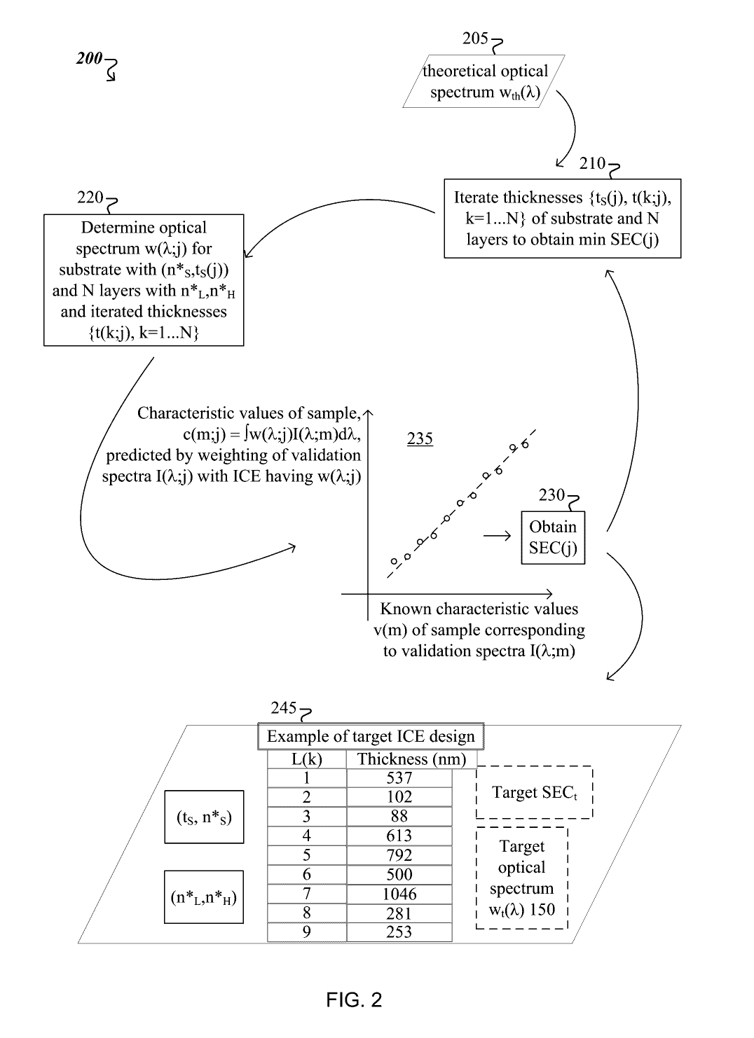

A set of design parameters 145 which includes the total number of stacked layers N, the complex refractive indices n*_{H}, n*_{L} of adjacent stacked layers, and the thicknesses of the N stacked layers t(1), t(2), . . . , t(N−1), t(N)—of the ICE 140 can be chosen (as described below in connection with FIG. 2) to be spectrally equivalent to the optical spectrum w(λ) 150 associated with the characteristic to be measured. As such, an ICE design includes a set 145 of thicknesses {t(i), i=1, . . . , N} of the N layers stacked on the substrate that correspond to the optical spectrum w(λ) 150.

In view of the above, the beam 155 of processed light output by the ICE 140 has a processed spectrum P(λ)=w(λ) [symbol] I(λ) 155′ over the wavelength range λₘₐₓ−λₘᵢₙ, such that the processed spectrum 155′ represents the modified spectrum I(λ) 135′ weighted by the optical spectrum w(λ) 150 associated with the characteristic to be measured.

The beam 155 of processed light is directed from the ICE 140 to the optical transducer 160, which detects the processed light and outputs an optical transducer signal 165. A value (e.g., a voltage) of the optical transducer signal 165 is a result of an integration of the processed spectrum 155′ over the particular wavelength range and is proportional to the unknown value “c” 165′ of the characteristic to be measured for the sample 130.

In some implementations, the well logging tool 110 can include a second ICE (not shown in FIG. 1A) associated with a second ICE design that includes a second set of thicknesses {t′(i), i=1, . . . , N′} of a second total number N′ of layers, each having a different complex refractive index from its adjacent layers, the complex refractive indices and the thicknesses of the N′ layers corresponding to a second optical spectrum w′(λ). Here, the second optical spectrum w′(λ) is associated with a second characteristic of the sample 130, and a second processed spectrum represents the modified spectrum I(λ) 135′ weighted by the second optical spectrum w′(λ), such that a second value of a second detector signal is proportional to a value of the second characteristic for the sample 130.

In some implementations, the determined value 165′ of the characteristic to be measured can be logged along with a measurement time, geo-location, and other metadata, for instance. In some implementations, the detector signal 165, which is proportional to a characteristic to be measured by the well logging tool 110, can be used as a feedback signal to adjust the characteristic of the sample, to modify the sample or environmental conditions associated with the sample, as desired.

Characteristics of the wellbore fluids 130 that can be related to the modified spectrum 135′ through the optical spectra associated with the ICE 140 and other ICEs (not shown in FIG. 1A) are concentrations of one of asphaltene, saturates, resins, aromatics; solid particulate content; hydrocarbon composition and content; gas composition C1-C6 and content: CO₂, H₂S and correlated PVT properties including GOR, bubble point, density; a petroleum formation factor; viscosity; a gas component of a gas phase of the petroleum; total stream percentage of water, gas, oil, solid articles, solid types; oil finger printing; reservoir continuity; oil type; and water elements including ion composition and content, anions, cations, salinity, organics, pH, mixing ratios, tracer components, contamination, or other hydrocarbon, gas, solids or water property.

### (2) Aspects of ICE Design

Aspects of a process for designing an ICE associated with a characteristic to be measured (e.g., one of the characteristics enumerated above) are described below. Here, an input of the ICE design process is a theoretical optical spectrum wₜₕ(λ) associated with the characteristic. An output of the ICE design process is an ICE design that includes specification of (1) a substrate and a number N of layers to be formed on the substrate, each layer having a different complex refractive index from its adjacent layers; and (2) complex refractive indices and thicknesses of the substrate and layers that correspond to a target optical spectrum wₜ(λ). The target optical spectrum wₜ(λ) is different from the theoretical optical spectrum wₜₕ(λ) associated with the characteristic, such that the difference between the target and theoretical optical spectra cause degradation of a target performance relative to a theoretical performance of the ICE within a target error tolerance. The target performance represents a finite accuracy with which an ICE having the target optical spectrum wₜ(λ) is expected to predict known values of the characteristic corresponding to a set of validation spectra of a sample with a finite (non-zero) error. Here, the predicted values of the characteristic are obtained through integration of the validation spectra of the sample respectively weighted by the ICE with the target optical spectrum wₜ(λ). The theoretical performance represents the maximum accuracy with which the ICE—if it had the theoretical optical spectrum wₜₕ(λ)—would predict the known values of the characteristic corresponding to the set of validation spectra of the sample. Here, the theoretically predicted values of the characteristic would be obtained through integration of the validation spectra of the sample respectively weighted by the ICE, should the ICE have the theoretical optical spectrum wₜₕ(λ).

FIG. 2 is a flow chart of an example of a process 200 for generating an ICE design. One of the inputs to the process 200 is a theoretical optical spectrum wₜₕ(λ) 205. For instance, to design an ICE for measuring concentration of a substance X in a mixture, a theoretical optical spectrum wₜₕ(λ), associated with the concentration of the substance X in the mixture, is accessed, e.g., in a data repository. As described above in this specification, the accessed theoretical optical spectrum wₜ(λ) corresponds to a spectral pattern detected offline, using a number N_{c} of calibration spectra of the mixture, each of the N_{c} calibration spectra corresponding to a known concentration of the substance X in the mixture. An additional input to the process 200 is a specification of materials for a substrate and ICE layers. Materials having different complex refractive indices, respectively, are specified such that adjacent ICE layers are formed from materials with different complex refractive indices. For example, a first material (e.g., Si) having a high complex refractive index n*_{H} and a second material (e.g., SiOₓ) having a low complex refractive index n*_{L} are specified to alternately form the ICE layers. As another example, a layer can be made from high index material (e.g., Si), followed by a layer made from low index material (e.g., SiOₓ), followed by a layer made from a different high index material (e.g., Ge), followed by a layer made from a different low index material (MgF₂), etc. The iterative design process 200 is performed in the following manner.

At 210 during the j^{th} iteration of the design process 200, thicknesses {t_{S}(j), t(1;j), t(2;j), . . . , t(N−1;j), t(N;j)} of the substrate and a number N of layers of the ICE are iterated.

At 220, a j^{th} optical spectrum w(λ;j) of the ICE is determined corresponding to complex refractive indices and previously iterated thicknesses {t_{S}(j), t(1;j), t(2;j), . . . , t(N−1;j), t(N;j)} of the substrate and the N layers, each having a different complex refractive index from its adjacent layers. The iterated thicknesses of the substrate and the N layers are used to determine the corresponding j^{th} optical spectrum w(λ;j) of the ICE in accordance with conventional techniques for determining spectra of thin film interference filters.

At 230, performance of the ICE, which has the j^{th} optical spectrum w(λ;j) determined at 220, is obtained. To do so, a set of validation spectra of a sample is accessed, e.g., in a data repository. Respective values of a characteristic of the sample are known for the validation spectra. For instance, each of Nᵥ validation spectra I(λ;m) corresponds to a value v(m) of the characteristic of the sample, where m=1, . . . , Nᵥ. In the example illustrated in FIG. 2, Nᵥ=11 validation spectra, respectively corresponding to 11 known values of the characteristic to be measured for the sample, are being used.

Graph 235 shows (in open circles) values c(m;j) of the characteristic of the sample predicted by integration of the validation spectra I(λ;m) weighted with the ICE, which has the j^{th} optical spectrum w(λ;j), plotted against the known values v(m) of the characteristic of the sample corresponding to the validation spectra I(λ;m). The predicted values c(m;1) of the characteristic are found by substituting, in formula 165′ of FIG. 1A, (1) the spectrum I(λ) 135′ of sample modified light with the respective validation spectra I(λ;m) and (2) the target spectrum wₜ(λ) 150 with the j^{th} optical spectrum w(λ;j). In this example, performance of the ICE, which has the j^{th} optical spectrum w(λ;j), is quantified in terms of a weighted measure of distances from each of the open circles in graph 235 to the dashed-line bisector between the x and y axes. This weighted measure is referred to as the standard calibration error (SEC) of the ICE. For instance, an ICE having the theoretical spectrum wₜₕ(λ) has a theoretical SECₜₕ that represents a lower bound for the SEC(j) of the ICE having the j^{th} spectrum w(λ;j) determined at 220 during the j^{th} iteration of the design process 200: SEC(j)>SECₜₕ.

In this specification, the SEC is chosen as a metric for evaluating ICE performance for the sake of simplicity. Note that there are other figures of merit that may be used to evaluate performance of ICE, as is known in the art. For example, sensitivity—which is defined as the slope of characteristic change as a function of signal strength—can also be used to evaluate ICE performance. As another example, standard error of prediction (SEP)—which is defined in a similar manner to the SEC except it uses a different set of validation spectra—can be used to evaluate ICE performance. Any of the figure(s) of merit known in the art is/are evaluated in the same general way by comparing theoretical performance with that actually achieved. Which figure(s) of merit or combinations are used to evaluate ICE performance is determined by the specific ICE design.

The iterative design process 200 continues by iterating, at 210, the thicknesses of the substrate and the N layers. The iterating is performed such that a (j+1) optical spectrum w(λ;j+1) determined at 220 from the newly iterated thicknesses—causes, at 230, improvement in performance of the ICE, to obtain SEC(j+1)<SEC(j). In some implementations, the iterative design process 200 is stopped when the ICE's performance reaches a local maximum, or equivalently, the SEC of the ICE reaches a local minimum. For example, the iterative process 200 can be stopped at the (j+1)^{th} iteration when the current SEC(j+1) is larger than the last SEC(j), SEC(j+1)>SEC(j). In some implementations, the iterative design process 200 is stopped when, for a given number of iterations, the ICE's performance exceeds a specified threshold performance for a given number of iterations. For example, the iterative design process 200 can be stopped at the j^{th} iteration when three consecutive SEC values decrease monotonously and are less than a specified threshold value: SEC₀>SEC(j−2)>SEC(j−1)>SEC(j).

In either of these cases, an output of the iterative process 200 represents a target ICE design 245 to be used for fabricating an ICE 140, like the one described in FIG. 1A, for instance. The ICE design 245 includes specification of (1) a substrate and N layers, each having a different complex refractive index from its adjacent layers, and (2) complex refractive indices n*_{S}, n*_{H}, n*_{L} and thicknesses {t_{S}(j), t(1;j), t(2;j), . . . , t(N−1;j), t(N;j)} of the substrate and N layers corresponding to the j^{th} iteration of the process 200. Additional components of the ICE design are the optical spectrum w(λ;j) and the SEC(j)—both determined during the j^{th} iteration based on the thicknesses {t_{S}(j), t(1;j), t(2;j), . . . , t(N−1;j), t(N;j)}. As the ICE design 245 is used as input for fabrication processes described herein, the iteration index j—at which the iterative process 200 terminates is dropped from the notations used for the components of the ICE design.

In this manner, the thicknesses of the substrate and the N layers associated with the ICE design 245 are denoted {t_{S}, t(1), t(2), . . . t(N−1), t(N)} and are referred to as the target thicknesses. The optical spectrum associated with the ICE design 245 and corresponding to the target thicknesses is referred to as the target optical spectrum wₜ(λ) 150. The SEC associated with the ICE design 245—obtained in accordance with the target optical spectrum wₜ(λ) 150 corresponding to the target thicknesses is—referred to as the target SECₜ. In the example illustrated in FIG. 2, the ICE design 245 has a total of N=9 alternating Si and SiO₂ layers, with complex refractive indices n_{Si}, n_{SiO2}, respectively. The layers' thicknesses (in nm) are shown in the table. An ICE fabricated based on the example of ICE design 245 illustrated in FIG. 2 is used to predict value(s) of concentration of substance X in wellbore fluids 130.

### (3) Technologies for Adjusting Fabrication of ICE

As described above in connection with FIG. 2, an ICE design specifies a number of material layers), each having a different complex refractive index from its adjacent layers. An ICE fabricated in accordance with the ICE design has (i) a target optical spectrum wₜ(λ) over an operational wavelength range [λₘᵢₙ, λₘₐₓ] and (ii) a target performance SECₜ, both of which correspond to the complex refractive indices and target thicknesses of the total number of layers specified by the ICE design. Performance of the ICE fabricated in accordance with the ICE design can be very sensitive to actual values of the complex refractive indices and thicknesses obtained during deposition. For a wide variety of reasons, the actual values of the complex refractive indices of materials to be deposited and/or the rate(s) of the deposition may drift within a fabrication batch or batch-to-batch, or may be affected indirectly by errors caused by measurement systems used to control the foregoing fabrication parameters. For example, materials used for deposition (Si, SiO₂) may be differently contaminated, or react differently due to different chamber conditions (e.g., pressure or temperature). For some layers of the ICE design 245, a small error, e.g., 0.1% or 0.001%, in the thickness of a deposited layer can result in a reduction in the performance of an ICE associated with the ICE design 245 below an acceptable threshold. Effects of fabrication errors on the performance of fabricated ICEs are minimized by monitoring the ICE fabrication.

For instance, the ICE fabrication can be monitored in-situ by performing optical monitoring. An optical monitor measures changes in intensity I(λ₁) of a quasi-monochromatic probe-light due to interaction with (e.g., transmission through or reflection from) formed layers of ICEs being fabricate. The quasi-monochromatic probe-light has either a single wavelength λ₁ or a center wavelength λ₁ within a narrow bandwidth Δλ, e.g., ±5 nm or less. A source of the quasi-monochromatic probe-light with the single wavelength λ₁ can be a continuous wave (CW) laser, for instance. The changes of the intensity of the quasi-monochromatic probe-light measured in-situ through optical monitoring are used to determine a complex refractive index and thickness of the formed layers of an ICE with which the quasi-monochromatic probe-light has interacted. Throughout this specification, determining a complex refractive index n* of a layer means that both the real component Re(n*) and the imaginary component Im(n*) of the complex refractive index are being determined. Conventionally, the wavelength λ₁ of quasi-monochromatic probe-light used to perform the in-situ optical monitoring is within the operational wavelength range [λₘᵢₙ, λₘₐₓ] of ICEs being fabricated. In contrast, a wavelength λ₁ of the quasi-monochromatic probe-light used by the disclosed in-situ optical monitoring is different from those in the operational wavelength range [λₘᵢₙ, λₘₐₓ] of the ICEs being fabricated. This aspect of the disclosed in-situ optical monitoring is responsible for the following potential benefits.

For example, assume that an operational wavelength range [λₘᵢₙ, λₘₐₓ] of the ICEs being fabricated is in a visible spectral region. However, at least some of the layers of these ICEs may be layers that are almost transparent to probe-light having a probe wavelength within the operational wavelength range [λₘᵢₙ, λₘₐₓ]. Such a subset of layers of the ICE may be made out of quartz, alumina, BK7, etc. In this case, an infrared (IR) probe—having a probe wavelength λ_{probe}>λₘₐₓ—is used in some embodiments of the disclosed optical monitoring, because the transparent layers may interact much stronger with the IR probe than with the probe having the probe wavelength within the visible wavelength range [λₘᵢₙ, λₘₐₓ]. In this manner, optical properties of the layers monitored with the IR probe are extrapolated to corresponding optical properties of the layers in the visible wavelength range [λₘᵢₙ, λₘₐₓ] using calculations known in materials science. The optical properties of the layers in the visible wavelength range [λₘᵢₙ, λₘₐₓ] where the ICEs will be operated can be obtained in the foregoing manner more accurately than if they were monitored directly with the probe having the probe wavelength within the visible wavelength range [λₘᵢₙ, λₘₐₓ]. In general, depending on layer material properties for an ICE with an operational wavelength range [λₘᵢₙ, λₘₐₓ], accuracy with which these layer material properties are monitored by the disclosed optical monitor 304 can increase when a wavelength of probe-light is either, λ_{probe}<λₘᵢₙ or λ_{probe}>λₘₐₓ relative to accuracy with which these layer material properties are monitored when the wavelength of the probe-light is within the operational range [λₘᵢₙ, λₘₐₓ].

As another example, in-situ optical monitoring during ICE deposition can be challenging to implement in IR or UV spectral ranges due to source and detector limitations. For instance, although the operational wavelength range [λₘᵢₙ, λₘₐₓ] of ICEs being fabricated may be in an IR spectral region, visible light sources may be stronger and more stable than IR sources and/or visible light detectors may be more sensitive than IR detectors. In some instances, visible light sources and detectors may be less expensive to acquire and operate than infrared sources and operate. For example, IR lasers are typically more expensive than comparable (performance-wise) visible lasers. As another example, some IR detectors require liquid N₂ cooling to achieve a signal-to-noise (S/N) ratio that is comparable to the one typically achieved by visible detectors. Hence, optical monitoring using a probe-light with a wavelength λ_{probe} in the visible spectral region can be more accurate than conventional optical monitoring using an IR probe having a wavelength within the operational wavelength range [λₘᵢₙ, λₘₐₓ]. In other cases, although an operational wavelength range [λₙ, λₘₐₓ] of ICES being fabricated may be in a UV spectral region, visible light detectors may be more sensitive than UV detectors. In this manner, optical monitoring using a probe-light with a wavelength λ_{probe} in the visible spectral region can be more accurate than conventional optical monitoring using a UV probe having a wavelength within the operational wavelength range [λₘᵢₙ, λₘₐₓ].

As yet another example, assume that the operational wavelength range [λₘᵢₙ, λₘₐₓ] of the ICES being fabricated is in an IR spectral region, e.g., from 3000 to 4000 nm. In such case, conventional optical monitoring based on quarter wave optics uses quasi-monochromatic probe-light having a wavelength of about 3500 nm. As accuracy of optical monitoring based on quarter wave optics is approximately 1/10^{th} wave, such accuracy is about 350 nm for the foregoing probe wavelength. In accordance with the disclosed technologies, a probe wavelength shorter than the operational wavelength range [λₘᵢₙ, λₘₐₓ] of the ICES being fabricated is employed in some embodiments of the disclosed optical monitoring, e.g., λ_{probe}≈500 nm<λₘᵢₙ, such that the 1/10^{th} wave accuracy represents 50 nm which corresponds to an improvement factor of 7 over conventional optical monitoring. Therefore, optical monitoring with probe-light having probe wavelength λ_{probe} that is shorter than the operational wavelength range [λₘᵢₙ, λₘₐₓ] of the ICES being fabricated, λ_{probe}<λₘᵢₙ, enables optical monitoring with superior accuracy during fabrication of ICES designed to be operated in the foregoing IR spectral region.

As precision of in-situ optical monitoring performed with probe-light having a wavelength 4-robe which satisfies either λ_{probe}<λₘᵢₙ or λ_{probe}>λₘₐₓ is larger than the precision of conventional in-situ optical monitoring performed with probe-light having a wavelength within the operational wavelength range [λₘᵢₙ, λₘₐₓ] of the ICES being fabricated, accuracy of determining the complex refractive indices and thicknesses of the formed layers based on the disclosed optical monitoring is improved relative to a corresponding determination based on conventional technologies. The complex refractive indices and thicknesses of the formed layers—which can be accurately determined in accordance with the disclosed technologies—are used during ICE fabrication to provide feedback for adjusting the ICE fabrication in real-time or near real-time. In this manner, the systems and techniques described herein can provide consistent batch-to-batch yields, and/or improvement of batch yield for the ICE fabrication.

Details of one or more of the foregoing embodiments are described below.

### (3.1) System for ICE Fabrication that Uses Optical Monitoring for which Wavelength of Quasi-Monochromatic Probe-Light is Outside of an Operational Range of ICEs being Fabricated

A target ICE design can be provided to an ICE fabrication system in which one or more ICEs are fabricated based on the target ICE design. Technologies are disclosed below for adjusting ICE fabrication in real-time or near real-time based on results of optical monitoring of characteristics of layers of ICEs being fabricated, such that a wavelength of quasi-monochromatic probe-light used by the in-situ optical monitoring is outside of an operational wavelength range of the ICEs being fabricated. A fabrication system for implementing these technologies is described first.

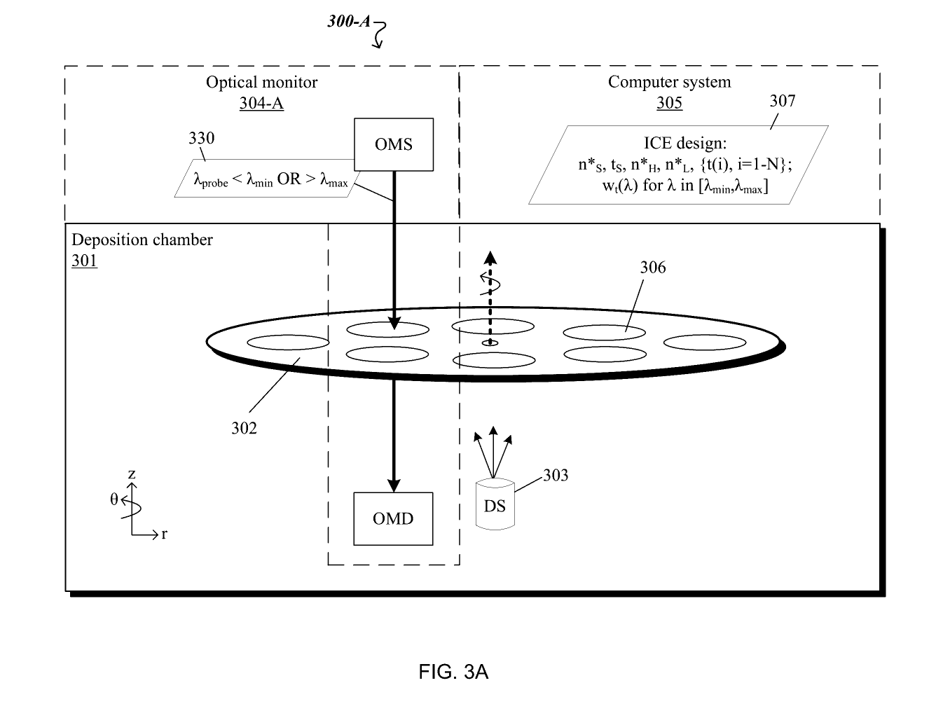

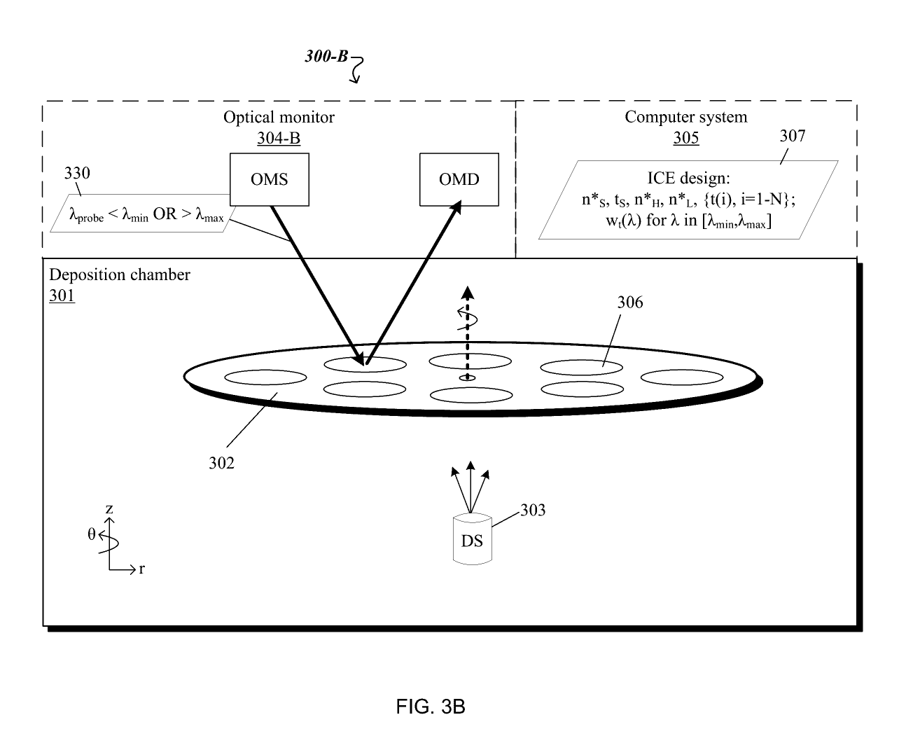

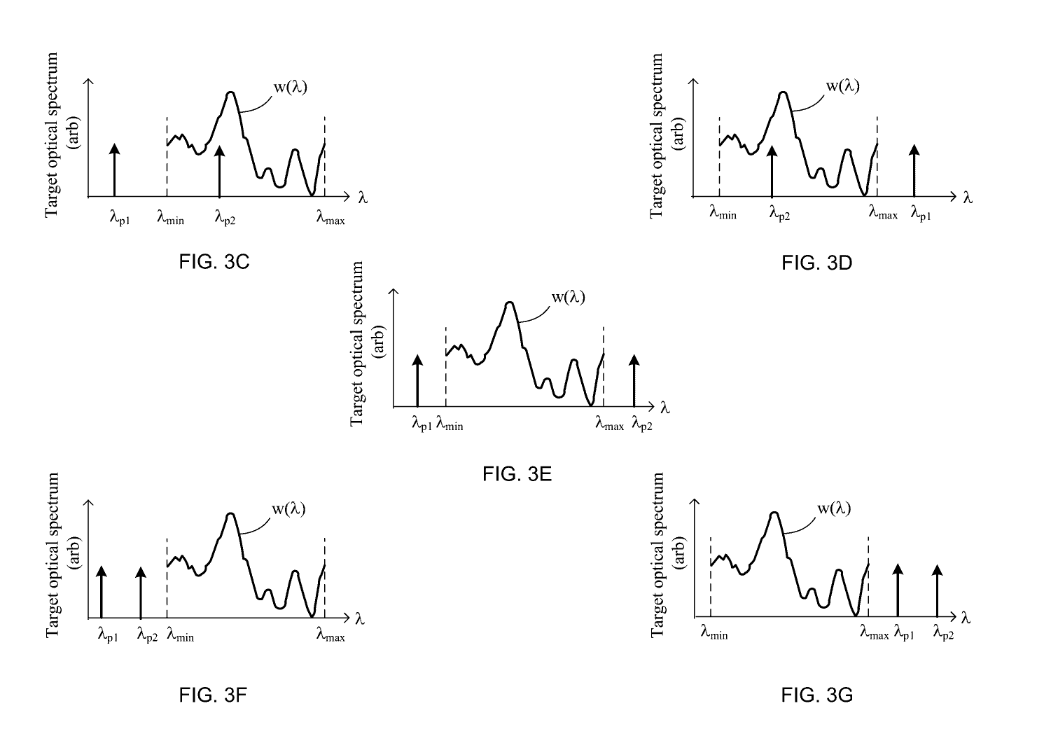

FIGS. 3A-3B show different configurations of an example of an ICE fabrication system 300. The ICE fabrication system 300 includes a deposition chamber 301 to fabricate one or more ICEs 306, an optical monitor 304 to measure change of intensity of quasi-monochromatic probe-light that interacted with formed layers of the ICEs while the ICEs are being fabricated, and a computer system 305 to control the fabrication of the one or more ICEs 306 based at least in part on results of the attenuation measurements. A configuration 300-A of the ICE fabrication system includes a transmittance configuration 304-A of the optical monitor, while another configuration 300-B of the ICE fabrication system includes a reflectance configuration 304-B of the optical monitor, as described in detail below.

The deposition chamber 301 includes one or more deposition sources 303 to provide materials with a low complex index of refraction n*_{L} and a high complex index of refraction n*_{H} used to form layers of the ICE 306. Substrates on which layers of the ICEs 306 will be deposited are placed on a substrate support 302, such that the ICEs 306 are within the field of view of the deposition source(s) 303. Various physical vapor deposition (PVD) techniques can be used to form a stack of layers of each of the ICEs 306 in accordance with a target ICE design 307. Here, the ICE design 307 includes specification of a thickness t_{S} and a complex refraction index n*_{S} of a substrate; complex indices of refraction n*_{H}, n*_{L} and target thicknesses {t(i), i=1−N} of N layers; and a corresponding target optical spectrum wₜ(λ), where λ is within an operational wavelength range [λₘᵢₙ, λₘₐₓ] of the ICE.

In accordance with PVD techniques, the layers of the ICE(s) are formed by condensation of a vaporized form of material(s) of the source(s) 305, while maintaining vacuum in the deposition chamber 301. One such example of PVD technique is electron beam (E-beam) deposition, in which a beam of high energy electrons is electromagnetically focused onto material(s) of the deposition source(s) 303, e.g., either Si, or SiO₂, to evaporate atomic species. In some cases, E-beam deposition is assisted by ions, provided by ion-sources (not shown in FIGS. 3A-3B), to clean or etch the ICE substrate(s); and/or to increase the energies of the evaporated material(s), such that they are deposited onto the substrates more densely, for instance. Other examples of PVD techniques that can be used to form the stack of layers of each of the ICEs 306 are cathodic arc deposition, in which an electric arc discharged at the material(s) of the deposition source(s) 303 blasts away some into ionized vapor to be deposited onto the ICEs 306 being formed; evaporative deposition, in which material(s) included in the deposition source(s) 303 is(are) heated to a high vapor pressure by electrically resistive heating; pulsed laser deposition, in which a laser ablates material(s) from the deposition source(s) 303 into a vapor; or sputter deposition, in which a glow plasma discharge (usually localized around the deposition source(s) 303 by a magnet—not shown in FIGS. 3A-3B) bombards the material(s) of the source(s) 303 sputtering some away as a vapor for subsequent deposition.

A relative orientation of and separation between the deposition source(s) 303 and the substrate support 302 are configured to provide desired deposition rate(s) and spatial uniformity across the ICEs 306 disposed on the substrate support 302. As a spatial distribution of a deposition plume provided by the deposition source(s) 303 is non-uniform along at least a first direction, current instances of ICEs 306 are periodically moved by the substrate support 302 relative to the deposition source 303 along the first direction (e.g., rotated along an azimuthal direction “θ” about an axis that passes through the deposition source(s) 303) to obtain reproducibly uniform layer deposition of the ICEs 306 within a batch.

Power provided to the deposition source(s) 303 and its arrangement relative to the current instances of ICEs 306, etc., can be controlled to obtain a specified deposition rate R. For instance, if an ICE design specifies that a j^{th} layer L(j) of the N layers of an ICE is a Si layer with a target thickness t(j), a stack including the previously formed ICE layers L(1), L(2), . . . , L(j−1) is exposed to a Si source from among the deposition sources 303 for a duration ΔT(j)=t(j)/R_{Si}, where the R_{Si} is a deposition rate of the Si source. Actual complex refractive indices and thicknesses of the 1^{st}, 2^{nd}, . . . , (j−1)^{th} and j^{th} a formed layers are determined by measuring with the optical monitor 304 change of intensity of quasi-monochromatic probe-light that interacted with the formed layers.

The optical monitor 304 is used to measure, e.g., during or after forming the j^{th} layer L(j) of the ICEs 306, change of intensity I(j;λ₁) of a quasi-monochromatic probe-light—provided by source OMS—due to interaction with (e.g., transmission through or reflection from) the stack with j layers of one or more ICEs 306 that are being formed in the deposition chamber 301. Here, the quasi-monochromatic probe-light has either a single wavelength λ₁ or a center wavelength λ₁ within a narrow bandwidth Δλ, e.g., ±5 nm or less. The interaction represents transmission through the current instance of the ICEs 306 in the transmittance configuration 304-A of the optical monitor, or reflection from the current instance of the ICEs 306 in the reflectance configuration 304-B of the optical monitor. In either of these configurations, the source OMS provides quasi-monochromatic probe-light with first wavelength λ₁ through a probe port of the deposition chamber 301 associated with the optical monitor 304, and a detector OMD collects, through a detector port of the deposition chamber 301 associated with the optical monitor 304, a first interacted light with intensity I(j;λ₁). In this manner, the measured change of intensity I(j;λ₁) of the quasi-monochromatic probe-light can be used by the computer system 305 to determine a set of complex refractive indices and thicknesses of each of the formed layers in the stack: n*′_{Si}, n′_{SiO2}, t′(1;λ₁), t′(2;λ₁), t′(j−1;λ₁), t′ (j;λ₁). The computer system 305 makes this determination by solving Maxwell's equations for propagating the interacted probe-light through the formed layers in the stack. Here, the argument “λ₁” indicates that the elements of the set are determined based on optical monitoring performed with a quasi-monochromatic probe-light that has a first wavelength λ₁.

In some implementations, an additional quasi-monochromatic probe-light with a second wavelength λ₂ different from the first wavelength λ₁ can be provided by the source OMS (or by a different source OMS′—not shown in FIGS. 3A and 3B) through the probe port of the deposition chamber 301 associated with the optical monitor 304, so the detector OMD (or a different detector OMD′—not shown in FIGS. 3A and 3B) collects, through the detector port of the deposition chamber 301 associated with the optical monitor 304, a second interacted light with an intensity I(j;λ₂). In this manner, both measured change of intensity I(j;λ₁) of the quasi-monochromatic probe-light with the first wavelength λ₁ and measured change of intensity I(j;λ₂) of the additional quasi-monochromatic probe-light with the second wavelength λ₂ are used to determine a second set of the complex refractive indices and thicknesses of each of the formed layers in the stack: n*″_{Si}, n*″_{SiO2}, t″(1; λ₁, λ₂), t″(2; λ₁, λ₂), . . . , t″(j−1; t″(j; λ₁, λ₂). Here, the compound argument λ₁, λ₂ indicates that the elements of the second set were determined based on optical monitoring performed with a combination of the quasi-monochromatic probe-light that has the first wavelength λ₁ and the additional quasi-monochromatic probe-light that has the second wavelength λ₂. Accuracy with which the complex refractive indices and thicknesses of the second set are determined based on optical monitoring that uses two quasi-monochromatic probes tends to be higher than the accuracy with which the complex refractive indices and thicknesses of the first set are determined based on optical monitoring that uses a single quasi-monochromatic probe.

A wavelength of the quasi-monochromatic probe-light used by a conventional optical monitor is within the operational wavelength range [λₘᵢₙ, λₘₐₓ] of the ICEs being fabricated. In contrast, the disclosed optical monitor 304 uses a quasi-monochromatic probe-light that has a wavelength λ_{probe} 330 different from those in the operational wavelength range [λₘᵢₙ, λₘₐₓ] of the ICEs being fabricated, such that λ_{probe}<λₘᵢₙ or λ_{probe}>λₘₐₓ. FIGS. 3C-3G show spectral locations of a first probe wavelength λₚ₁ of a quasi-monochromatic probe-light relative to the operational wavelength range [λₘᵢₙ, λₘₐₓ] of the ICEs being fabricated, and spectral locations of optional combinations of the first probe wavelength λₚ₁ of the quasi-monochromatic probe-light and a second probe wavelength λₚ₂ of an additional quasi-monochromatic probe-light.

In FIG. 3C, the first probe wavelength λₚ₁ is shorter than the operational wavelength range [λₘᵢₙ, λₘₐₓ] of the ICEs being fabricated: λₚ₁<λₘᵢₙ. For example, while wavelengths of the operational wavelength range [λₘᵢₙ, λₘₐₓ] of the ICEs being fabricated are in the visible spectral region, the first probe wavelength λₚ₁ is in the UV spectral region. In FIG. 3D, the first probe wavelength λₚ₁ is larger than the operational wavelength range [λₘᵢₙ, λₘₐₓ] of the ICEs being fabricated: λₘₐₓ<λₚ₁. For example, while wavelengths of the operational wavelength range [λₘᵢₙ, λₘₐₓ] of the ICEs being fabricated are in the visible spectral region, the first probe wavelength λₚ₁ is in the IR spectral region. In both examples illustrated in FIGS. 3C-3D, an additional quasi-monochromatic probe-light can be optionally used, such that a second probe wavelength λₚ₂ of the additional quasi-monochromatic probe-light is within the operational wavelength range [λₘᵢₙ, λₘₐₓ] of the ICEs being fabricated: λₚ₁<λₘᵢₙ<λₚ₂<λₘₐₓ or λₘᵢₙ<λₚ₂<λₘₐₓ<λₚ₁.

In FIG. 3E, the first probe wavelength 41 is shorter and the second probe wavelength λₚ₂ is longer than wavelengths of the operational wavelength range [λₘᵢₙ, λₘₐₓ] of the ICEs being fabricated: λₚ₁<λₘᵢₙ<λₘₐₓ<λₚ₂. For example, while wavelengths of the operational wavelength range [λₘᵢₙ, λₘₐₓ] of the ICEs being fabricated are in the visible spectral region, the first probe wavelength λₚ₁ is in the UV spectral region and the second probe wavelength λₚ₂ is in the IR spectral region. In FIG. 3F, the first probe wavelength λₚ₁ and the second probe wavelength λₚ₂ of the optional additional quasi-monochromatic probe-light both are shorter than wavelengths of the operational wavelength range [λₘᵢₙ, λₘₐₓ] of the ICEs being fabricated: λₚ₁<λₚ₂<λₘᵢₙ. For example, wavelengths of the operational wavelength range [λₘᵢₙ, λₘₐₓ] of the ICEs being fabricated may be in the IR spectral region while the first and second probe wavelengths λₚ₁, λₚ₂ are in the visible spectral region. In FIG. 3G, the first probe wavelength λₚ₁ and the second probe wavelength λₚ₂ of the optional additional quasi-monochromatic probe-light both are longer than wavelengths of the operational wavelength range [λₘᵢₙ, λₘₐₓ] of the ICEs being fabricated: λₘₐₓ<λₚ₁<λₚ₂. For example, wavelengths of the operational wavelength range [λₘᵢₙ, λₘₐₓ] of the ICEs being fabricated may be in the UV spectral region while the first and second probe wavelengths λₚ₁, λₚ₂ are in the visible spectral region.

In accordance with the disclosed technologies, the formed layers of an instance of any one or more of the ICEs 306 disposed on the substrate support 302 can be illuminated with a quasi-monochromatic probe-light beam provided by the optical monitor 304 to monitor ICE layer deposition in the deposition chamber 301.

In some implementations, a particular one of the current instance of the ICEs 306, referred to as a witness sample, is at rest (along with the other of the current instance of the ICEs 306) relative to the optical monitor 304 when the quasi-monochromatic probe-light beam illuminates the witness sample. Here, deposition of a layer L(j) is interrupted or completed prior to illuminating the current instance of the one of the ICEs 306 by the optical monitor 304. For some of the layers of an ICE design, the optical monitor 304 measures in-situ the attenuation of the interacted quasi-monochromatic probe-light after the layer L(j) has been deposited to its full target thickness t(j), or equivalently, when deposition of the layer L(j) is completed. For some of the layers of the ICE design, the optical monitor 304 measures the attenuation of the interacted quasi-monochromatic probe-light during the deposition of the layer L(j). For example, such a measurement can be taken when the layer L(j) has been deposited to a fraction of its target thickness f*t(j), e.g., where f=50%, 80%, 90%, 95%, etc.

In other implementations, particular one or more of the current instance of ICEs 306, referred to as one or more witness samples, move relative to the optical monitor 304, e.g., are rotated by the substrate support 302 about its center along with the other of the current instance of the ICEs 306, when the attenuation of the interacted quasi-monochromatic probe-light is measured. Here, deposition of the layer L(j) may—but need not be—interrupted or completed prior to performing the optical monitoring. For some of the layers of the ICE design, measurements of attenuation of the interacted quasi-monochromatic probe-light can be taken continuously for the entire duration ΔT(j) of the deposition of the layer L(j), or at least for portions thereof, e.g., last 50%, 20%, 10% of the entire duration ΔT(j). In these implementations, a signal corresponding to the change of intensity of quasi-monochromatic probe-light interacted with the one or more witness samples is collected by the optical monitor 304's detector OMD during the time when the moving one or more witness samples are illuminated by the quasi-monochromatic probe-light. For example, as the movement of the one or more witness samples is periodic, the signal of interest is averaged over a number of periods of the periodic motion, for instance over 5 periods. As another example, a number M≧2 of witness samples disposed along the direction of motion can be successively illuminated by the quasi-monochromatic probe-light over each period of the periodic motion. Here, the signal of interest is averaged over the number M of witness samples. Whether for a single witness sample or for multiple witness samples, no signal is collected, by the optical monitor 304's detector OMD for the remainder of a period of the periodic motion, when the quasi-monochromatic probe-light does not illuminate the one or more witness samples.

One complication with optical monitoring using near-infrared (NIR) or infrared (IR) quasi-monochromatic probe-light is that stray light emanating from any warm (e.g., a blackbody) surface inside the deposition chamber 301 enters the optical monitor 304's detector OMD and interferes with the change of intensity measurement. To avoid these complications, the optical monitor 304 measures and averages change of intensity of the quasi-monochromatic probe-light that interacted with one or more ICEs 306 during a period of ICEs 306's periodic motion. In this manner, as the substrate support 302 moves periodically, a quasi-monochromatic probe-light beam of the optical monitor 304 alternately illuminates an ICE, and then the quasi-monochromatic probe-light beam is blocked (in the transmittance configuration 304-A or absorbed in the reflectance configuration 304-B) by the physical substrate support 302 until the next ICE enters the quasi-monochromatic probe-light beam. An intensity-change signal corresponding to change of intensity of quasi-monochromatic probe-light due to interaction with the formed layers of the ICEs 306 is recorded by the detector OMD when the quasi-monochromatic probe-light beam illuminates the ICEs 306 that cross the quasi-monochromatic probe-light beam, and a background signal is recorded by the detector OMD when the quasi-monochromatic probe-light beam illuminates adjacent to (in between) the ICEs 306 and it is physically hindered from reaching the detector SD. The background signal can be used to compensate, or zero out, much of noise contributions of the stray light from the intensity-change signal associated with the deposited layers. The foregoing allows for accurate background corrections and thus enables recording by the optical monitor 304 of an accurate change of intensity associated with the deposited layers of the ICEs 306.

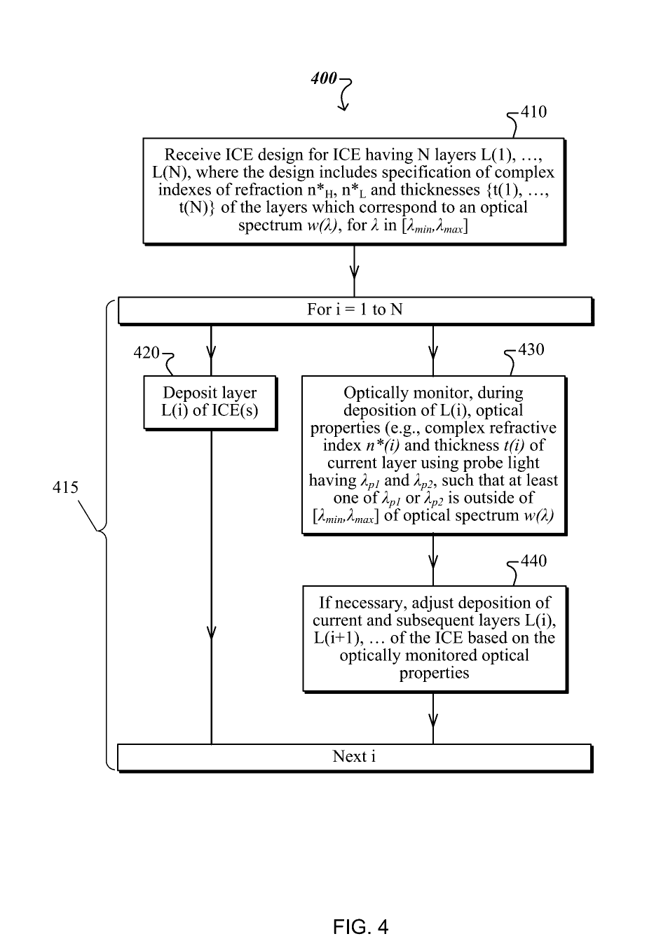

The computer system 305 includes one or more hardware processors and memory. The memory encodes instructions that, when executed by the one or more hardware processors, cause the fabrication system 300 to perform processes for fabricating the ICEs 306. Examples of such processes are described below in connection with FIG. 4. The computer system 305 also includes or is communicatively coupled with a storage system that stores one or more ICE designs 307, aspects of the deposition capability, and other information. The stored ICE designs can be organized in design libraries by a variety of criteria, such as ICE designs used to fabricate ICEs for determining values of a particular characteristic over many substances (e.g. the GOR ratio in crude oil, refined hydrocarbons, mud, etc.), or ICE designs used to fabricate ICEs for determining values of many properties of a given substance (e.g., viscosity, GOR, density, etc., of crude oil.) In this manner, upon receipt of an instruction to fabricate an ICE for measuring a given characteristic of a substance, the computer system 305 accesses such a design library and retrieves an appropriate ICE design 307 that is associated with the given characteristic of the substance.

The retrieved ICE design 307 includes specification of a substrate and a total number N of layers to be formed in the deposition chamber 301 on the substrate; specification of a complex refractive index n*_{S} of a material of the substrate, a high complex refractive index n*_{H} and a low complex refractive index n*_{L} of materials (e.g., Si and SiO₂) to form the N layers with adjacent layers having different complex refractive indices; and specification of target thicknesses {t_{S}, t(k), k=1−N} of the substrate and the N layers. Implicitly or explicitly, the ICE design 307 also can include specification of a target optical spectrum wₜ(λ) associated with the given characteristic, the target optical spectrum wₜ(λ) being specified over an operational wavelength range [λₘᵢₙ, λₘₐₓ] associated with the ICE design 307; and specification of a target SECₜ representing expected performance of an ICE associated with the retrieved ICE design 307. The foregoing items of the retrieved ICE design 307 were determined, prior to fabricating the ICEs 306, in accordance with the ICE design process 200 described above in connection with FIG. 2. In some implementations, the ICE design 307 can include indication of maximum allowed SECₘₐₓ caused by fabrication errors. Figures of merit other than the target SECₜ can be included in the retrieved ICE design 307, e.g., SEP, the ICE sensitivity, etc.

The complex refractive indices and target thicknesses {t(k), k=1−N} of the N layers, as specified by the retrieved ICE design 307, are used by the computer system 305, in conjunction with aspects of deposition capability of the ICE fabrication system 300, to control deposition rate(s) of the deposition source(s) 303 and respective deposition times for forming the ICE layers. While forming the ICE layers, the computer system 305 instructs the optical monitor 304 to optically monitor optical properties (e.g., complex refractive indices and thicknesses) of formed layers of one or more ICEs being fabricated by the ICE fabrication system 300 using quasi-monochromatic probe-light that has a probe wavelength 330 that is outside of the operational wavelength range associated with the received ICE design 307. If necessary, the computer system 305 then instructs the ICE fabrication system 300 to adjust the forming of layers remaining to be formed based on the optically monitored optical properties of the formed layers of the ICE.

### (3.2) Adjusting of ICE Fabrication Based on Results of In-Situ Optical Monitoring for which Wavelength of Quasi-Monochromatic Probe-Light is Outside of an Operational Range of Fabricated ICEs

FIG. 4 is a flow chart of an example of an ICE fabrication process 400 for fabricating ICEs that uses the optical monitoring techniques described above in connection with FIGS. 3A-3G. The process 400 can be implemented in conjunction with the ICE fabrication system 300 to adjust ICE fabrication. In such a context, the process 400 can be implemented as instructions encoded in the memory of the computer system 305, such that execution of the instructions, by the one or more hardware processors of the computer system 305, causes the ICE fabrication system 300 to perform the following operations.

At 410, an ICE design is received. The received ICE design includes specification of a substrate and N layers L(1), L(2), . . . , L(N), each having a different complex refractive index from its adjacent layers, and specification of target complex refractive indices and thicknesses t_{S}, t(1), t(2), . . . t(N). In this manner, an ICE fabricated in accordance with the received ICE design selectively weights, when operated, light in at least a portion of a wavelength range [λₘᵢₙ, λₘₐₓ] by differing amounts. The differing amounts weighted over the wavelength range correspond to a target optical spectrum wₜ(λ) of the ICE and are related to a characteristic of a sample. The wavelength range [λₘᵢₙ, λₘₐₓ] associated with the target optical spectrum wₜ(λ) is also referred to as the operational wavelength range [λₘᵢₙ, λₘₐₓ] of the ICE. For example, a design process for determining the specified (1) substrate and number N of layers of the ICE, each having a different complex refractive index from its adjacent layers, and (2) complex refractive indices and thicknesses of the substrate and the N layers that correspond to the target optical spectrum wₜ(λ) of the ICE is described above in connection with FIG. 2. In some implementations, the received ICE design also can include SECₜ as an indication of a target performance of the ICE. The target performance represents an accuracy with which the ICE predicts, when operated, known values of the characteristic corresponding to validation spectra of the sample. Here, predicted values of the characteristic are obtained when the validation spectra weighted by the ICE are respectively integrated. In some implementations, the received ICE design also can include indication of maximum allowed SECₘₐₓ caused by fabrication errors.

Loop 415 is used to fabricate one or more ICEs based on the received ICE design. Each iteration “i” of the loop 415 is used to form a layer L(i) of a total number N of layers. Here, the total number N of layers can be either specified in the received ICE design or updated during the ICE fabrication. Updates to the received ICE design are performed when necessary for preventing performance of the fabricated ICE to degrade under a threshold value.

At 420, the layer L(i) is formed to a target thickness t(i). The target thickness t(i) of the layer L(i) can be specified by the received ICE design or updated based on optimization(s) carried out after forming previous one or more of the layers of the ICE. For some of the layers of the ICE, a deposition source having a deposition rate R is used for a total time duration ΔT(i)=t(i)/R to deposit the layer L(i) to its target thickness as part of a single deposition step. Other layers are deposited to the target thickness t(i) using multiple deposition steps by discretely or continuously forming respective sub-layers of the layer L(i). Here, the deposition rate used for depositing each of the sub-layers can be the same or different from each other. In the case when the deposition rates for forming the sub-layers are different, the last few sub-layers of the layer L(i) can be formed using slower rates than the ones used for forming the first few sub-layers of the layer L(i).

At 430, while the layer L(i) is being formed, optical properties of the previously formed layers L(1), L(2), . . . , L(i−1) and of the layer L(i) that is currently being formed are monitored using quasi-monochromatic probe-light that has a wavelength λₚ₁ outside of the operational wavelength range [λₘᵢₙ, λₘₐₓ] of the ICEs, λₚ₁<λₘᵢₙ or λₘₐₓ<λₚ₁. In the examples illustrated in FIGS. 3A and 3B, the optical monitor 304 measures change of intensity I(j;λₚ₁) of the quasi-monochromatic probe-light with wavelength 330 that interacts with (e.g., in the transmittance configuration 304-A of the optical monitor, quasi-monochromatic probe-light transmits through, or in the reflectance configuration 304-B of the optical monitor, quasi-monochromatic probe-light reflects from) the current instances of the ICEs 306 being fabricated in the deposition chamber 301. The computer system 305 determines—based on values of the measured change of intensity I(j;λₚ₁) complex refractive indices and thicknesses n*′_{Si}, n*′_{SiO2}, t′(1), t′(2), . . . , t′(i−1) of the formed layers and a complex refractive index n*′(i) and a thickness t′(i) of the layer currently being formed.

In other implementations described above in connection with FIGS. 3A-3G, the complex refractive indices and thicknesses of the formed layers are determined from results of optical monitoring performed using a combination of the quasi-monochromatic probe-light that has the wavelength λₚ₁ outside of the operational wavelength range [λₘᵢₙ, λₘₐₓ] of the ICEs, and additional quasi-monochromatic probe-light that has a wavelength λₚ₂. In some cases, both probe wavelengths λₚ₁, λₚ₂ are outside of the operational wavelength range [λₘᵢₙ, λₘₐₓ] of the ICEs, e.g., λₚ₁<λₚ₂<λₘᵢₙ (as shown in FIG. 3F), λₘₐₓ<λₚ₁<λₚ₂ (as shown in FIG. 3G), or λₚ₁<λₘᵢₙ<λₚ₁<λₚ₂ (as shown in FIG. 3E.) In some other cases, the probe wavelength λₚ₂ of the additional quasi-monochromatic probe-light is within the operational wavelength range [λₘᵢₙ, λₘₐₓ] of the ICEs, λₚ₁<λₘᵢₙ<λₚ₂<λₘₐₓ (as shown in FIG. 3A) or λₘᵢₙ<λₚ₂<λₘₐₓ<λₚ₁ (as shown in FIG. 3B.)

For some of the layers of the received ICE design, the disclosed optical monitoring can be skipped altogether. For some other layers, the disclosed optical monitoring is carried out continuously during the deposition of a layer L(i), in some implementations. In other implementations, the disclosed optical monitoring is performed a finite number of times during the deposition of the layer L(i). In the latter case, the finite number of times can represent times when at least some of the sub-layers of the layer L(i) are completed.

At 440, deposition of current and subsequent layers L(i), L(i+1), . . . of the ICE(s) is adjusted if necessary, based on the optically monitored complex refractive indices and thicknesses n*′_{Si}, n*′_{SiO2}, t′(1), t′(2), . . . t′(i−1), t′(i) of previously formed layers L(1), L(2), . . . , L(i−1) and of the layer L(i) currently being formed. For example, a deposition rate and/or a time used to form the layer L(i) currently being formed and other layers L(i+1), L(i+2), L(N) remaining to be formed can be adjusted based on a comparison between values of the complex refractive indices and thicknesses of the layers of the current instance of the ICEs and their respective target values. Alternatively or additionally, complex refractive indices corresponding to the layer L(i) currently being formed and other layers L(i+1), L(i+2), . . . , L(N) remaining to be formed can be adjusted based on a comparison between values of the complex refractive indices and thicknesses of the layers of the current instance of the ICEs and their respective target values.

Further, in order to determine whether target thicknesses of the layer L(i) being current formed and other layers L(i+1), L(i+2), . . . , L(N) remaining to be formed should be updated, the following verification is performed. An SEC(i) of the ICE is predicted to represent the ICE's performance if the ICE were completed to have the formed layers L(1), L(2), . . . , L(i−1) with the determined thicknesses t′(1), t′(2), . . . , t′(i−1), and the layer L(i) currently being formed and other layers L(i+1), L(i+2), . . . , L(N) remaining to be formed with target thicknesses t(i), t(i), . . . t(N). Here, the predicted SEC(i) is caused by deviations of the determined complex refractive indices and thicknesses of the formed layers from their respective complex refractive indices and target thicknesses specified by the current ICE design. If the predicted SEC(i) does not exceed the maximum allowed SECₘₐₓ, SEC(i)≦SECₘₐₓ, then the forming of the current layer L(i) is completed in accordance to its target thickness t(i) and a next iteration of the loop 415 will be triggered to form the next layer L(i+1) to its target thickness t(i+1).

If, however, the predicted SEC(i;N) exceeds the maximum allowed performance degradation SECₘₐₓ, SEC(i;N)>SECₘₐₓ, then target thicknesses of the layer L(i) currently being formed and other layers L(i+1), L(i+2), . . . , L(N) remaining to be formed are modified based on the determined complex refractive indices and thicknesses of the formed layers L(1), L(2), . . . , L(i). This optimization may change the total number of layers of the ICE from the specified total number N of layers to a new total number N′ of layers, but constrains the thicknesses of the layers L(1), L(2), . . . , L(i) (of the current instance of the ICE) to the determined thicknesses t′(1), t′(2), . . . , t′(i). In this manner, the optimization obtains, in analogy with the process 200 described above in connection with FIG. 2, new target thicknesses t″(i), t″(i+1), . . . , t″(N′) of the layer L(i) currently being formed and other layers L(i+1), . . . , L(N′) remaining to be formed, such that a new target SEC′ₜ(i;N′) of the ICE for the ICE having the first layers L(1), L(2), . . . , L(i−1) formed with the determined thicknesses t′(1), t′(2), . . . , t′(i−1), and the layer L(i) currently being formed and other layers L(i+1), . . . , L(N′) remaining to be formed with the new target thicknesses t″(i), t″(i+1), . . . , t″(N′) is minimum and does not exceed the maximum allowed SECₘₐₓ, SEC′ₜ(i;N′)≦SECₘₐₓ. Moreover, the previous instance of the ICE design is updated with specification of the new total number of layers N′ and the new target thicknesses t″(i), t″(i+1), . . . , t″(N′) which are used to form the current layer L(i) and the remaining layers L(i+1), . . . , L(N′) and correspond to the new target SEC′ₜ(i;N′).

Once one or more of the foregoing adjustments are implemented at 440, the forming of the current layer L(i) is completed in accordance with its new target thickness t″(i) and a next iteration of the loop 415 will be triggered to form the next layer L(i+1) from the new total number of layers N′ to its new target thickness t″(i+1). In this manner, the remaining layers of the ICE will be formed in accordance with the implemented adjustments, at least until another adjustment is performed.

Some embodiments have been described in detail above, and various modifications are possible. While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Other embodiments fall within the scope of the following claims.

1. A method comprising:
receiving, by a fabrication system, a design of an integrated computational element (ICE), the ICE design comprising specification of a substrate and a plurality of layers, their respective target thicknesses and complex refractive indices, wherein complex refractive indices of adjacent layers are different from each other, and wherein a notional ICE fabricated in accordance with the ICE design is related to a characteristic of a sample over an operational wavelength range;
forming, by the fabrication system, at least some of the layers of the ICE in accordance with the ICE design;
optically monitoring, during said forming, by a measurement system associated with the fabrication system, optical properties of the formed layers using quasi-monochromatic probe-light having a probe wavelength that is outside of the operational wavelength range of the ICE; and
adjusting, by the fabrication system, said forming, at least in part, based on the optically monitored optical properties of the formed layers of the ICE.

2. The method of claim 1, wherein the centered probe wavelength is shorter than wavelengths of the operational wavelength range of the ICE.

3. The method of claim 2, wherein said optically monitoring the optical properties of formed layers is performed using the quasi-monochromatic probe-light having the probe wavelength that is outside of the operational wavelength range of the ICE and at least one additional quasi-monochromatic probe-light having another different probe wavelength.

4. The method of claim 3, wherein the other probe wavelength is shorter than wavelengths of the operational wavelength range of the ICE.

5. The method of claim 3, wherein the other probe wavelength is longer than wavelengths of the operational wavelength range of the ICE.

6. The method of claim 3, wherein the other probe wavelength is within the operational wavelength range of the ICE.

7. The method of claim 1, wherein the probe wavelength is longer than wavelengths of the operational wavelength range of the ICE.

8. The method of claim 7, wherein said optically monitoring the optical properties of formed layers is performed using the quasi-monochromatic probe-light having the probe wavelength that is outside of the operational wavelength range of the ICE and at least one additional quasi-monochromatic probe-light having another different probe wavelength.

9. The method of claim 8, wherein the other probe wavelength is longer than wavelengths of the operational wavelength range of the ICE.

10. The method of claim 8, wherein the other probe wavelength is within the operational wavelength range of the ICE.

11. The method of claim 1, wherein
the operational wavelength range of the ICE spans near-IR and IR spectral regions, and
the probe wavelength is in the UV-visible spectral region.

12. The method of claim 1, wherein
the operational wavelength range of the ICE spans visible and near-IR spectral regions, and
the probe wavelength is in the IR spectral region.

13. The method of claim 1, wherein
the operational wavelength range of the ICE spans the UV spectral region, and
the probe wavelength is in the visible spectral region.

14. The method of claim 1, wherein said adjusting comprises updating a deposition rate used to form the layers remaining to be formed based on the optically monitored optical properties of the formed layers of the ICE.

15. The method of claim 1, wherein said adjusting comprises modifying complex refractive indices of the layers remaining to be formed based on the optically monitored optical properties of the formed layers of the ICE.

16. The method of claim 1, wherein said adjusting comprises modifying target thicknesses of the layers remaining to be formed based on the optically monitored optical properties of the formed layers of the ICE.

17. The method of claim 1, wherein said adjusting comprises changing a total number of layers specified by the ICE design to a new total number of layers.

18. A system comprising:
a deposition chamber;
one or more deposition sources associated with the deposition chamber to provide materials from which layers of one or more integrated computational elements (ICEs) are formed, wherein an ICE design associated with the ICEs specifies an operational wavelength range of the ICEs;
one or more supports disposed inside the deposition chamber, at least partially, within a field of view of the one or more deposition sources to support the layers of the ICEs while the layers are formed;
an optical monitor associated with the deposition chamber to monitor one or more characteristics of the layers while the layers are formed, wherein the optical monitor comprises one or more light sources to emit quasi-monochromatic probe-light having a probe wavelength that is outside of the operational wavelength range of the ICEs; and
a computer system in communication with at least some of the one or more deposition sources, the one or more supports and the optical monitor, wherein the computer system comprises one or more hardware processors and non-transitory computer-readable medium encoding instructions that, when executed by the one or more hardware processors, cause the system to form the layers of the ICEs by performing operations comprising:
receiving an ICE design comprising specification of a substrate and a plurality of layers, their respective target thicknesses and complex refractive indices, wherein complex refractive indices of adjacent layers are different from each other, and wherein a notional ICE fabricated in accordance with the ICE design is related to a characteristic of a sample over an operational wavelength range;
forming at least some of the layers of the ICEs in accordance with the ICE design;
optically monitoring, by the optical monitor during said forming, optical properties of the formed layers using quasi-monochromatic probe-light having a probe wavelength that is outside of the operational wavelength range; and
adjusting said forming, at least in part, based on the optically monitored optical properties of the formed layers of the ICE.

19. The system of claim 18, wherein the one or more light source of the optical monitor to emit the quasi-monochromatic probe-light having the probe wavelength that is outside of the operational wavelength range of the ICEs and at least one additional quasi-monochromatic probe-light having another different probe wavelength.

20. The system of claim 19, wherein the other probe wavelength is outside of the operational wavelength range of the ICEs.

21. The system of claim 19, wherein the other probe wavelength is within the operational wavelength range of the ICEs.
